(19) United States
(12) Patent Application Publication
(10) Pub. No.: US 2004/0033857 A1
(43) Pub. Date: Feb. 19, 2004

(54) Belt

(76) Inventors: Susan Welk, Lakewood, CO (US); Paul S. Knutson, Aurora, CO (US)

Correspondence Address: Jeffrey Thurnau, The Gates Corporation, Mail Stop 31-4-1-A3, 900 S. Broadway, Denver, CO, 80209, US

(21) Appl. No.: 10/218,712

(22) Filed: Aug. 13, 2002

(51) Int. Cl. F16G 1/00; F16G 9/00

(52) U.S. Cl. 474/263; 474/260

(57) ABSTRACT

A belt having an elastomeric body and tensile cord embedded therein. The tensile cord comprises a polyamide 4.6 non-twisted strand inner core with an outer sheath of polyester strands wound about the inner core. The modulus of the belt is in the range of approximately 1200 N/mm to 4000 N/mm.

### FIELD OF THE INVENTION

The invention relates to a power transmission belt and more particularly to a low modulus belt having a core spun nylon and polyester tensile member.

### BACKGROUND OF THE INVENTION

Power transmission belts are widely used to transmit rotary power. A belt is generally installed between a driver and driven pulley, such as in the case of an accessory belt drive on a vehicle engine.

The belt comprises a tensile cord embedded in an elastomeric material. The tensile cord, or cords, are oriented parallel to a longitudinal axis in order to maximize a load carrying capability. The tensile cord is wound on a belt build in a continuous manner during fabrication.

Power transmission belts must possess sufficient tensile strength to allow a required torque, and load, to be transmitted between pulleys.

A belt having a high tensile strength also will generally have a commensurately high modulus. A belt having a high modulus will be relatively stiff. Further, installation of a prior art high modulus belt requires moveable axis pulleys.

A low modulus belt may be used in situations where the torque to be transmitted is less than that required for a high load application. Low modulus belts are fabricated using tensile cords with a predetermined preload, or little or no preload. They may be fabricated using tensile cords having a twist as well. The material selected for the tensile cord will have the greatest effect on the modulus of the belt. Polyamide 4.6 is known for such use.

Representative of the art is EP 0 625 650 to Gates that discloses a low modulus belt having a tensile cord wound with a preload in a longitudinal direction.

Also representative of the art is U.S. Pat. No. 6,033,331 to Winninger et al. (2000) which discloses a belt having a supporting structure such that the belt exhibits an average stress-elongation slope ranging from 12 to 20 daN/% of elongation per width centimeter.

The prior art teaches use of a tensile cord comprising only polyamide 4.6 twisted strands. Use of a single material for the tensile cord limits the modulus range for a belt.

What is needed is a belt having a tensile cord comprising a polyamide 4.6 non-twisted strand inner core with an outer strand of polyester wound about the inner core. What is needed is a belt having a modulus in the range of approximately 1200 N/mm to 4000 N/mm. The present invention meets these needs.

### SUMMARY OF THE INVENTION

The primary aspect of the invention is to provide a belt having a tensile cord comprising a polyamide 4.6 non-twisted strand inner core with an outer strand of polyester wound about the inner core.

Another aspect of the invention is to provide a belt having a modulus in the range of approximately 1200 N/mm to 4000 N/mm.

Other aspects of the invention will be pointed out or made obvious by the following description of the invention and the accompanying drawings.

The invention comprises a belt having an elastomeric body and tensile cord embedded therein. The tensile cord comprises a polyamide 4.6 non-twisted strand inner core with an outer sheath of polyester strands wound about the inner core. The modulus of the belt is in the range of approximately 1200 N/mm to 4000 N/mm.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a cross-sectional view of an inventive belt.

FIG. 2 is a side view of a tensile member having a filament strand core.

FIG. 3 is a side view of a tensile member having a twisted core.

FIG. 4 is a side view of a tensile member having a twisted sheath.

FIG. 5 is a schematic diagram of a core spinning process.

### DETAILED DESCRIPTION OF THE PREFERRED EMBODIMENT

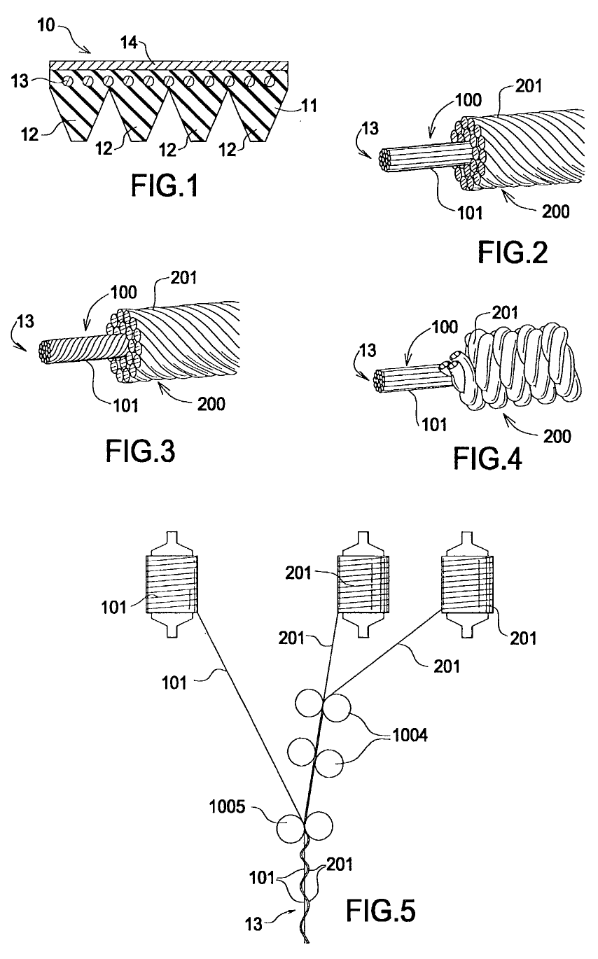

FIG. 1 is a cross-sectional view of an inventive belt. Belt 10 comprises elastomeric body 11 and a fabric overcord layer 14. Layer 14 may comprise any suitable fabric used in the art. The inventive belt may also be manufactured without layer 14.

Tensile members 13 extend in an endless longitudinal direction within the belt elastomeric body 11. Belt 10 comprises ribs 12. Ribs 12 extend in an endless direction. Although four ribs are depicted in FIG. 1, the number of ribs are determined according to an operational need. A single rib may also be used as well.

FIG. 2 is a side view of a tensile member having a strand core. Tensile member 13 is a hybrid composition that comprises a strand core 100 within an outer sheath 200.

Core 100 comprises a plurality of non-twisted mono-filaments or strands 101 bundled together. Strands 101 are not twisted together, but instead are each disposed parallel to each respective adjacent strand.

Each strand 101 comprises polyamide 4.6 in the preferred embodiment. Strands 101 may also comprise polyamide 6, polyamide 6.6 and polyamide 12, and all equivalents thereof, and combinations of two or more of the foregoing. Strands 101 have a thickness in the range of approximately 11 to 380 μm.

Sheath 200 comprises a strand or strands 201 wound about core 100. Strands 201 comprise polyester or aramid or a combination of the foregoing. Strands 201 have a thickness in the range of approximately 11 to 380 μm. Strands 201 may have either an “S” or “Z” twist.

FIG. 3 is a side view of a tensile member having a twisted core. In this embodiment core 100 comprises two or more twisted strands 101 of polyamide 4.6. Strands 101 may also comprise polyamide 6, polyamide 6.6 and polyamide 12, and all equivalents thereof, and combinations of two or more of the foregoing. Core 100 is enclosed in a sheath 200 comprising strands 201. Strands 101 and 201 have a thickness in the range of approximately 11 to 380 μm. Strands 201 may comprise polyester or aramid or a combination of the foregoing. Strands 101 and 201 may have either an “S” or “Z” twist.

Elastomeric body 11 may comprise natural or synthetic rubbers, including but not limited to EPDM (ethylenepropylene diene rubber), HNBR (hydrogenated acrylonitrilebutadiene rubber), PU (polyurethane), ACSM (alkylated chlorosulfonated polyethylene), CR (chloroprene rubber), SBR (styrene-butadiene rubber), NBR (nitrile rubber) and equivalents, or a combination of two of more of the foregoing.

The method for manufacturing the belts comprises winding the tensile members about the gum sheets on a belt blank. The tensile members are wound about the gum sheets on a drum with a pre-load tension in the range of approximately 18 to 65 newtons. Applying a pre-load to the tensile members during manufacturing provides improved control of a tensile member location within the belt body. Minimizing deviations from a proper placement of the tensile members within the belt body results in reduced tensile member failure and increased belt life.

The inventive belt has an elastic modulus relative to the belt width and measured in the lengthwise direction in the range of 1200 N/mm to 4000 N/mm per belt strand. Said measurement comprises a stress-strain curve average slope from a stress range of 150 to 300 N/rib/strand on the third of three belt elongation cycles. This results in an elongation in the range of approximately 2% to approximately 5.5%.

The belt test apparatus includes a tensile test machine, such as an Instron® or equivalent known in the art. To test, a belt is placed in an inverted position on a set of test pulleys in the tensile test machine. Inverted meaning the ribbed portion is not engaged with the test pulleys. The test pulleys are not rotated during the test. The belt is subjected to three load cycles on the test machine in order to stabilize the belt. The belt modulus is determined from the third of three load cycles on the test machine. The belt is tested at a temperature of approximately 23° C. ±2° C.

FIG. 4 is a side view of a tensile member having a twisted sheath. Strands 201 are twisted together having either an “S” or “Z” twist. Twisted strands 201 are then spun about the outside of core strands 100 to form a tensile member. Core strands 101 are not twisted together, but instead, each strand is disposed parallel to each respective adjacent strand, as described and shown in FIG. 2.

FIG. 5 is a schematic diagram of a core spinning process. Core spinning is known in the textile arts. The process depicted in FIG. 4 is shown as an example and not as a limitation. A core strand 101 and sheath strands 201 are each drawn from spindles. Sheath strands 201 are first twisted or spun together by being drawn through drafting rolls 1004. The twisted sheath strands 201 are then twisted about core strand 101 by passage through delivery rolls 1005 resulting in the tensile member configuration shown in FIG. 2 and FIG. 3, for use in the belt described in FIG. 1.

Although a single form of the invention has been described herein, it will be obvious to those skilled in the art that variations may be made in the construction and relation of parts without departing from the spirit and scope of the invention described herein.

I claim:

1. A belt comprising:
an elastomeric body;
a tensile member embedded in the elastomeric body;
the tensile member comprises a non-twisted polyamide 4.6 strand and an outer strand wound about the polyamide 4.6 strand; and
the belt having a stress-elongation diagram which exhibits an average slope ranging from approximately 1200 N/mm to 4000 N/mm per belt strand.

2. The belt as in claim 1, wherein the outer strand comprises polyester or aramid or a combination of the foregoing.

3. A belt comprising:
an elastomeric body;
a tensile member embedded in the elastomeric body, the tensile member comprises at least two strands of polyamide 4.6 twisted together and an outer strand wound about the twisted polyamide 4.6 strands; and
the belt having a stress-elongation diagram which exhibits an average slope in the range of greater than 2000 N/mm to approximately 4000 N/mm per belt strand.

4. The belt as in claim 3, wherein the outer strand comprises polyester or aramid or a combination of the foregoing.

5. A belt comprising:
an elastomeric body;
a tensile member embedded in the elastomeric body;
the tensile member comprises a non-twisted strand and an outer strand wound about the non-twisted strand; and
the belt having a stress-elongation diagram which exhibits an average slope ranging from approximately 1200 N/mm to 4000 N/mm per belt strand.

6. The belt as in claim 5 wherein the outer strand substantially comprises polyester or aramid or a combination of the foregoing.

7. The belt as in claim 6 wherein the non-twisted strand is selected from polyamide 4.6, polyamide 6, polyamide 6.6, polyamide 12, or a combination of two or more of the foregoing.

8. The belt as in claim 5, wherein the tensile member is wound about the gum sheets on a drum with a preload tension in the range of approximately 18 to 65 newtons.
